(19) United States
(12) Patent Application Publication
(10) Pub. No.: US 2025/0259234 A1
(43) Pub. Date: Aug. 14, 2025

(54) SYSTEM AND METHOD FOR MONITORING ACTIVITIES OF CHILDREN USING A PIGGY BANK

(71) Applicant: MONKEEYS FINTECH PRIVATE LIMITED, Coimbatore (IN)

(72) Inventor: DHAVANESSH SOUNDARARAJAN, Coimbatore (IN)

(21) Appl. No.: 19/050,712

(22) Filed: Feb. 11, 2025

(30) Foreign Application Priority Data
Feb. 11, 2024 (IN) 202441009652

(51) Int. Cl. G06Q 40/02; A45C 1/12; G07D 11/34; G07D 11/60; G09B 19/00

(52) U.S. Cl. CPC G06Q 40/02; A45C 1/12; G07D 11/34; G07D 11/60; G09B 19/00

(57) ABSTRACT

A system for monitoring activities of children using an intelligent piggy bank is provided. The system 100 includes piggy bank 102 associated with child, a server 104, and user device 106 associated with parent/guardian. The piggy bank 102 (i) detects, using sensor unit 110, deposition of currency, when currency is inserted by child; (ii) activates, by microcontroller 118, relay switch 112 and motor 114 to receive currency; (iii) calculates, amount of currency; (iv) generates currency deposit request by including amount of currency in structured deposit request, when child submits first approval request through interactive display 116; (v) communicates currency deposit request to user device 106 through server 104, where user device 106 receives currency deposit request and enables parent/guardian to approve currency deposit request; and (vi) credits currency into piggy bank by updating balance of piggy bank 102, when the currency deposit request is approved by the parent/guardian.

### BACKGROUND

### Technical Field

The embodiments herein generally relate to promoting financial education in children, more particularly to a system and method for monitoring activities of children to foster financial management skills in children using a piggy bank. This system and method serve as an effective tool for teaching children about the importance of saving, budgeting, and financial responsibility from an early age.

### Description of the Related Art

Financial management skills are crucial for individuals and organizations to effectively manage their financial resources and make informed decisions. The financial management skills include budgeting, financial planning, cash flow management, risk management, and financial analysis.

Lack of financial management skills may result in various consequences, both in a short term and a long term. Common issues associated with the lack of financial management skills are impulse spending, inadequate savings habits, poor budgeting skills, inability to set and achieve financial goals and strained relationships. Further, a lack of financial education can contribute to financial stress in adulthood. Individuals who haven't learned proper money management skills may struggle with debt, living pay check to pay check, and financial insecurity. Individuals who haven't acquired financial management skills may become dependent on others for financial support. This dependence can limit their independence and autonomy. A lack of financial skills may result in missed opportunities for wealth-building activities such as investing. Understanding how to make money work for them is crucial for long-term financial success. Introducing financial education to children early by providing practical examples, and encouraging responsible money habits can help children develop the skills needed for a financially secure future.

There are some existing money management applications proposed to impart financial skills in children that primarily focus on tracking expenses or allowances, providing limited educational content about broader financial concepts such as budgeting, saving, and investing. Some of the existing applications may have tie-ins with commercial products or services. Parents should be cautious about exposing their children to potential advertising or commercial influences within the application. Combining the use of money management applications with practical, real-world experiences can provide a more comprehensive and well- rounded financial education for children. Regular communication and involvement from parents remain crucial for effective learning.

Accordingly, there remains a need for a system and method to foster financial literacy, promote responsible behaviour, and encourage technological proficiency among children, thereby benefiting both parents, kids and society as a whole.

### SUMMARY

In view of a foregoing, an embodiment herein provides a system for monitoring activities of children to foster financial management skills. The system includes a piggy bank that is associated with a child and is configured to: (i) detect, using a sensor unit, a deposition of currency, when the currency is inserted by the child into a currency entry slot, where the currency includes at least one of coins or banknotes; (ii) activate, by a microcontroller, a relay switch and a motor to receive the currency, when the deposition of the currency is detected by the sensor unit; (iii) calculate, by the microcontroller, an amount of the currency by analyzing characteristics of the currency using an image processing technique to obtain analysed data and comparing the analysed data with predefined profiles of different currency types to identify the amount of the currency; (iv) generate, by the microcontroller, a currency deposit request by including the amount of the currency in a structured deposit request, when the child submits a first approval request through an interactive display for currency deposit; (v) communicate, by the microcontroller, the currency deposit request to a user device associated with a parent/guardian of the child through a server, where the user device receives the currency deposit request from the server through a user interface and enables the parent/guardian to approve the currency deposit request; (vi) credit, by the microcontroller, the currency into the piggy bank by updating a balance of the piggy bank associated with the child based on the received currency, when the currency deposit request is approved by the parent/guardian, thereby monitoring the saving activity of the children to foster financial management skills in children.

In some embodiments, the piggy bank is configured to generate a currency withdrawal request by the microcontroller when the child submits a second approval request through the interactive display for currency withdrawal.

In some embodiments, the microcontroller is configured to send a control signal to the relay switch, which deactivates a lock mechanism for a storage space of the currency to access the currency when the currency withdrawal request is approved by the parent/guardian.

In some embodiments, the microcontroller displays the status of denial on the interactive display, if the parent/guardian denies the currency deposit request or currency withdrawal request.

In some embodiments, the user interface associated with the user device enables the parent/guardian to create at least one task with a timeline for completion and a corresponding reward, where the at least one task is displayed in the interactive display of the piggy bank as pending tasks.

In some embodiments, the user interface associated with the user device is configured to track savings of the child over a period of time and enable the parent/guardian to create at least one goal with a timeline for achieving the goal and monthly contribution of the child to achieve the goal, where the at least one goal is displayed in the interactive display of the piggy bank as pending goals.

In some embodiments, the piggy bank includes a chip card inserting functionality that enables secure transactions, fund additions, and balance inquiries, and a fingerprint sensor that enables the parent/guardian to lock and unlock the piggy bank using a fingerprint.

In one aspect, a method for monitoring saving activity of children to foster financial management skills in children is provided. The method includes (i) providing a piggy bank that is associated with a child, where the piggy bank includes a sensor unit, a relay switch, a motor, an interactive display, and a microcontroller; (ii) detecting, using a sensor unit, a deposition of currency when the currency is inserted by the child into a currency entry slot, where the currency includes at least one of coins or banknotes; (iii) activating, by a microcontroller, a relay switch and a motor to receive the currency, when the deposition of the currency is detected by the sensor unit; (iv) calculating, by the microcontroller, an amount of the currency by analyzing characteristics of the currency using an image processing technique to obtain analysed data and comparing the analysed data with predefined profiles of different currency types to identify the amount of the currency; (v) generating, by the microcontroller, a currency deposit request by including the amount of the currency in a structured deposit request when the child submits a first approval request through an interactive display for currency deposit; (vi) communicating, by the microcontroller, the currency deposit request to a user device associated with a parent/guardian of the child through a server; (vii) receiving, by the user device, the currency deposit request from the server through a user interface for approval by the parent/guardian, where the user device enables the parent/guardian to approve the currency deposit request; (viii) crediting, by the microcontroller, the currency into the piggy bank by updating a balance of the piggy bank associated with the child based on the received currency, when the currency deposit request is approved by the parent/guardian, thereby monitoring the saving activity of the children to foster financial management skills in children.

In some embodiments, the method includes (a) generating a currency withdrawal request by the microcontroller by including an amount of currency to be withdrawn in a structured withdrawal request, when the child submits a second approval request through the interactive display for currency withdrawal; (b) transmitting the currency withdrawal request to the user device for approval; (c) allowing the child to withdraw the currency from the piggy bank using the microcontroller by controlling the relay switch and the motor, when the currency withdrawal request is approved by the parent/guardian through the user interface; and (d) updating the balance of the piggy bank by the microcontroller based on the withdrawn currency.

In some embodiments, the relay switch activates or deactivates a lock mechanism by the microcontroller by allowing or cutting off power to the motor to access a storage space of the piggy bank.

The system of the present disclosure improves the saving habits of children daily as well as goal-based savings which teaches children about the value of money. By tracking their savings and setting financial goals, children can develop a better understanding of money management, which can have long-term benefits for their financial well-being as adults. The system has the potential to foster financial literacy, promote responsible behaviour, and encourage technological proficiency among children, thereby benefiting both parents, kids and society as a whole. The system helps children to include financial concepts and their value in their younger stage. Parents and children can move towards a digital economy which is most popular nowadays.

The system makes parents set goals for their children and make them active and engaged in useful work. Through the system, the children learn to earn, save, and invest within their parent's control. Since approval is required from parents for money withdrawal, this system comes as a secured one.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system monitoring activities of children to foster financial management skills according to some embodiments herein;

FIG. 2 is a block diagram that illustrates modules associated with a microcontroller of FIG. 1 according to some embodiments herein;

FIG. 3 is a block diagram that illustrates modules associated with a user interface of user device of FIG. 1 according to some embodiments herein;

FIG. 4 illustrates exemplary user interfaces of that display monitoring of saving activity of child according to some embodiments herein;

FIG. 5 illustrates exemplary user interfaces that show creating tasks for a child by a parent/guardian according to some embodiments herein;

FIG. 6 illustrates exemplary user interfaces that show creating goals for a child by a parent/guardian according to some embodiments herein;

FIG. 7A is an exemplary view of a piggy bank of FIG. 1 according to some embodiments herein;

FIG. 7B is an exemplary view that illustrates different views of a piggy bank of FIG. 1 according to some embodiments herein;

FIGS. 8A-8B are flow diagrams that illustrates a method monitoring saving activity of children to foster financial management skills using a system of FIG. 1 according to some embodiments herein; and

FIG. 9 is a schematic diagram of a computer architecture in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

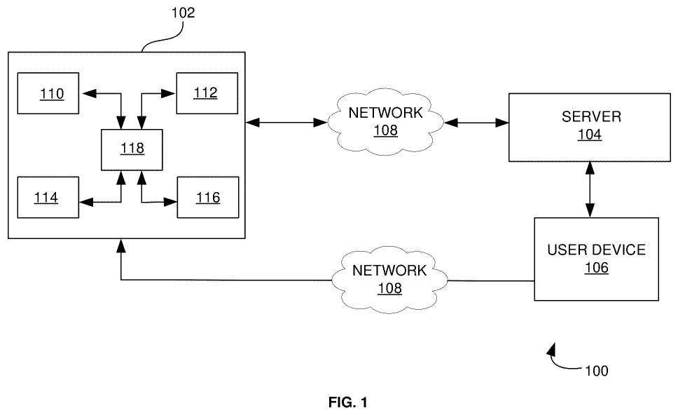

As mentioned, there remains a need for a system and method to foster financial literacy, promote responsible behaviour, and encourage technological proficiency among children, thereby benefiting both parents, kids and society as a whole. Embodiments herein achieve this by proposing a system and method for monitoring saving activity of children to foster financial management skills in children. Referring now to the drawings, and more particularly to FIGS. 1 through 9, where similar reference characters denote corresponding features consistently throughout the figure, preferred embodiments are shown.

FIG. 1 illustrates a system 100 monitoring activities of children to foster financial management skills according to some embodiments herein. The system 100 includes a piggy bank 102, a server 104, a user device 106 and a network 108. The piggy bank 102 includes a sensor unit 110, a relay switch 112, a motor 114, an interactive display 116 and a microcontroller 118.

The piggy bank 102 may be associated with a child and is configured to detect a deposition of currency using the sensor unit 110, when the currency is inserted by the child. The currency may be at least one of coins or banknotes. The sensor unit 110 may be positioned near the currency entry slot. The sensor unit 110 may be at least one of infra-red (IR) sensor, optical sensor, weight sensor, capacitive sensor, or magnetic sensor. In some embodiments, the sensor unit 110 is infra-red (IR) sensor. The IR sensor is configured to emit an infrared beam across the currency entry slot or passage. When the currency is inserted, the beam gets interruption which is detected by the IR sensor. The currency entry slot may include one or more slots. The piggy bank 102 may include a first currency entry slot for receiving coins and a second currency entry slot for receiving banknotes.

The piggy bank 102 is further configured to activate the relay switch 112 and the motor 114 to receive the currency using the microcontroller 118, when the deposition of the currency is detected by the sensor unit 110. The microcontroller 118 may be a Raspberry Pi four microcontroller. The microcontroller 118 acts as a brain of the piggy bank 102 and handles input, data storage, and various other functionalities. The relay switch 112 is configured to create a mechanism that opens or closes the piggy bank 102 based on specified digital inputs, ensuring controlled access to the stored currency in the storage space. The relay switch 112 may be configured to control the storage space electronically with a lock mechanism. Upon receiving a signal from the sensor unit 110, the microcontroller 118 activates the relay switch 112, which serves as an electronic switch to control the motor 114. The relay switch 112 may activate or deactivate the lock mechanism by allowing or cutting off power to the motor 114 as needed. The motor 114 is configured to pull the currency into the piggy bank 102 and stores in the storage space. For coins, the motor 114 may rotate a sorting mechanism, open a trapdoor, or move an arm. For banknotes, the motor 114 may engage rollers or a conveyor to pull the banknotes. Once the currency is received, the relay switch 112 activates the lock mechanism by allowing power to the motor 114, which moves a latch, or locking arm into place to secure the storage space. The relay switch 112 cuts off power, keeping the lock engaged.

The piggy bank 102 is further configured to calculate an amount of the currency using the microcontroller 118. The microcontroller 118 may analyze characteristics of the currency using an image processing technique to obtain an analysed data and comparing the analysed data with pre-defined profiles of different currency types to identify the amount of the currency. The analysed data may include diameter, thickness, color, edge pattern, embossed markings, serial number, denomination value, size, color pattern, and security features (e.g., watermarks).

The piggy bank 102 is further configured to generate a currency deposit request using the microcontroller 118, when the child submits a first approval request through the interactive display 116 for currency deposit. The first approval request refers to the child's action of initiating a currency deposit. The microcontroller 118 implements an input mechanism to interact with the piggy bank 102 through the interactive display 116. The interactive display 116 may be an LCD screen with or without keypad, or a LED screen with or without keypad. The microcontroller 118 may include or add the amount of the currency that is received in a structured deposit request to generate the currency deposit request, when the child submits the first approval request through the interactive display 116 for currency deposit. The structured deposit request may include deposit type (coin or banknote), amount, timestamp (date and time of the deposit request), user ID (if the piggy bank supports multiple users), and approval status (pending or approved).

The piggy bank 102 with its microcontroller 118 is further configured to communicate the currency deposit request to the user device 106 through the server 104. The user device 106 may be associated with a parent/guardian of the child and may be a handheld device, a mobile phone, a Personal Digital Assistant (PDA), a tablet, a music player, a computer, a laptop, an electronic notebook or a Smartphone. The server 104 is communicatively connected with the piggy bank 102 and the user device 106 through the network 108 to manage savings. In some embodiments, the network 108 is wired. In some embodiments, the network 108 is a wireless network based on at least one Wi-Fi, wireless Ethernet, or Bluetooth. In some embodiments, the network 108 is a combination of a wired network and a wireless network. In some embodiments, the network 108 is the Internet.

The server 104 may present a user interface on the user device 106 associated with the parent/guardian. The user interface may be a mobile application or a web application. For mobile applications, the user interface involves one or more design and layout of elements on a smartphone or tablet screen. The user interface may include visual components including buttons, icons, menus, and the overall arrangement of information. For web applications, the user interface may extend to the one or more design and layout of elements within a web browser. The one or more design and layout of elements include navigation menus, buttons, forms, and the overall visual presentation of information. The server 104 may be a cloud, mobile phone, or computer. The server 104 may allow users (for example, parents) to create and track personal accounts and sub-accounts linked to the piggy bank 102 through the user interface.

The parent/guardian creates an account through the user interface by registering with their mobile number. The parent/guardian is required to provide their name, nick name (optional) and generate a PIN to create the account by agreeing with the service terms and conditions. The parent/guardian logs in to their account using their mobile number and PIN. The parent/guardian creates a member by providing the details including name, nickname (optional), date of birth, gender and relationship type. The created members are added under the family members of the parent/guardian. For example, a person can add his wife, and children as family members. The account details of the children include total savings amount, digital savings, goals savings, pending goals, and achieved goals. The user interface may include an option to facilitate scanning a QR code associated with the piggy bank 102 of the child. The parent/guardian scans the QR code associated with the piggy bank 102 and gets connected to the piggy bank 102.

The user device 106 is configured to receive the currency deposit request from the server 104 through the user interface and enables the parent/guardian to approve the currency deposit request. Once approved by the parent/guardian through the user interface, the currency can be deposited to the piggy bank 102. The microcontroller 118 is configured to credit the currency into the piggy bank 102 by updating a balance of the piggy bank 102 associated with the child based on the received currency, when the currency deposit request is approved by the parent/guardian. The balance of the piggy bank 102 is displayed on the interactive display 116. The microcontroller 118 may also display messages or other relevant information along with the current balance for the child and parent/guardian to track the funds/currency in the piggy bank 102.

Similar to currency deposit request, the piggy bank 102 is further configured to generate a currency withdrawal request by the microcontroller 118, when the child submits a second approval request through the interactive display 116 for currency withdrawal. The second approval request refers to the child's action of initiating a currency withdrawal. The currency withdrawal request may also be transmitted to the user device 106 for the approval. Once approved by the parent/guardian through the user interface, the currency can be withdrawn from the piggy bank 102. The relay switch 112 may be configured to control a physical access to the stored currency in the storage space. In some embodiments, the microcontroller 118 is configured to send a control signal to the relay switch 112, which deactivates the lock mechanism for the storage space of the currency to access the currency, when the currency withdrawal request is approved by the parent/guardian. After withdrawal, the microcontroller 118 may update the balance of the piggy bank 102 based on the withdrawal currency, and display the balance on the interactive display 116.

If the parent/guardian denies the currency deposit request or currency withdrawal request, the status of denial is displayed on the interactive display 116 by the microcontroller 118. Thus, the system 100 monitors the saving activity of the children, thereby fostering their financial management skills.

In some embodiments, the user device 106 associated with the parent/guardian is configured to track savings of the child over a period of time and aids to set financial goals for the child based on the savings through the user interface. The user interface associated with the user device 106 enables the parent/guardian to create at least one task and allocate the at least one task to the children who are added as the family members. The task may be created by providing a task title, and task description. A relevant image may be added to the task. For example, the task may be related to encouraging vegetable-eating habits in the children. The parent/guardian may create a timeline for completing the task and may include a reward for the completion of the task. The created tasks are added to the task list of the children and displayed in the interactive display 116 of the piggy bank 102 as pending tasks.

The user interface associated with the user device 106 further enables the parent/guardian to create at least one goal and allocate the at least one goal to the children who are added as the family members. The goal may be created by providing a goal title, a timeline for achieving the goal and monthly contribution of the child to achieve the goal. A relevant image may be added to the goal. The user interface also provides goal details including the monthly contribution with respect to date. For example, the goal may be related to buying a bicycle. The created goals are added to the goal list of the children and displayed in the interactive display 116 of the piggy bank 102 as pending goals.

In some embodiments, the piggy bank 102 includes a fingerprint sensor. The parent/guardian can lock and unlock the piggy bank 102 using a fingerprint. In some embodiments, the piggy bank 102 includes a chip card inserting functionality. A debit card or any relevant card may be inserted for all the day-to-day transactions and can be used to add funds and check balances. The piggy bank 102 may be attached to any external device such as a TV or a mobile display. The piggy bank 102 may be provided with an in-build app store that facilitates downloading and facilitating apps like YouTube or games. By using QR code display options, anyone can scan and send or pay money to the account linked with the piggy bank 102 directly.

In some embodiments, the piggy bank 102 supports product-to-application connectivity, enabling communication between the piggy bank 102 and a mobile application for monitoring and approvals. The piggy bank 102 may include a low-end connectivity mode, where the piggy bank 102 connects to a basic mobile application solely for transaction approvals by the parent/guardian.

In some embodiments, the piggy bank 102 includes a music system and is integrated with audio output and lights to provide interactive feedback when currency is deposited or withdrawn. In some embodiments, the piggy bank 102 is equipped with USB charging functionality, allowing convenient recharging of its internal power source. In some embodiments, the system 100 includes a digital wallet for savings, allowing virtual transactions and balance tracking through the user device 106. In some embodiments, the server 104 initiates savings directly into bank accounts associated with the parent or guardian, helping to transfer the deposited amount into real savings accounts. This ensures secure and structured financial management for the child's savings.

In some embodiments, children can learn about financial concepts such as counting currency, identifying denominations, and basic investment principles through the interactive display 116, thereby turning financial education into a fun and engaging experience. The interactive display 116 may have a virtual currency counting game where children practice adding or subtracting coins and banknotes, helping them learn the value of different denominations. The interactive display 116 may show images or simulations of different coins and bills, and children can match them with the correct values. For example, the piggy bank 102 may prompt the child to select a coin of a certain value to deposit, helping them learn the differences between them. The interactive display 116 may introduce simple games or challenges where children make virtual investments or save for goals. This may include visualizing how savings grow over time, or learning about concepts like interest or budgeting. Thus, the system 100 makes learning about money interactive and engaging by incorporating fun challenges, games, and visual aids.

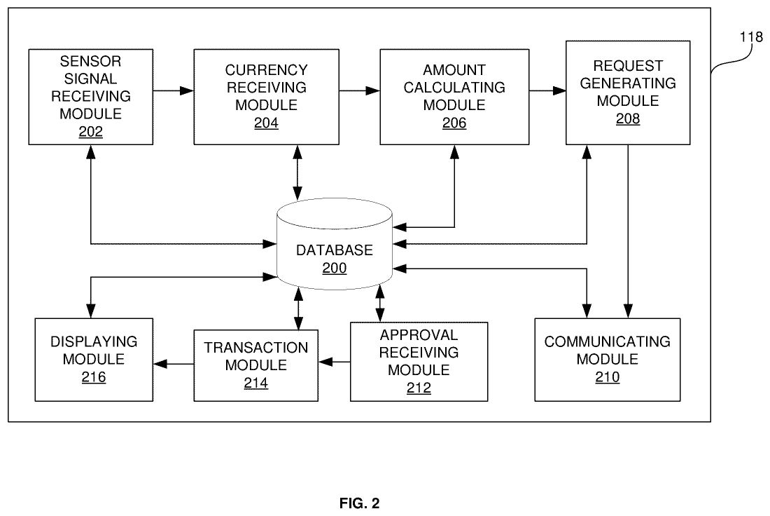

FIG. 2 is a block diagram that illustrates modules associated with a microcontroller 118 of FIG. 1 according to some embodiments herein. A piggy bank 102 includes the microcontroller 118 and a first database 200. The first database 200 stores one or more modules and sequences of instructions, which when executed by the microcontroller 118 causes monitoring of a saving activity of child. The one or more modules include a sensor signal receiving module 202, a currency receiving module 204, an amount calculating module 206, a request generating module 208, a communicating module 210, an approval receiving module 212, a transaction module 214, and a displaying module 216.

The sensor signal receiving module 202 receives a signal associated with a deposition of currency from a sensor unit 110 when the sensor unit 110 detects changes caused by the insertion of the currency.

The currency receiving module 204 activates a relay switch 112 and a motor 114 to receive the currency, when the signal associated with the deposition of the currency is received at the sensor signal receiving module 202. The currency receiving module 204 controls the relay switch 112 that activates or deactivates a lock mechanism by allowing or cutting off power to the motor 114 as needed. The relay switch 112 in turn controls the motor 114 that pulls the currency into the piggy bank 102 and stores in a storage space.

The amount calculating module 206 calculates an amount of the currency that is received at the currency receiving module 204. The amount calculating module 206 analyzes one or more characteristics of the currency to obtain analysed data. The amount calculating module 206 may use an image processing technique to obtain the analysed data. The analysed data may include diameter, thickness, color, edge pattern, embossed markings, serial number, denomination value, size, color pattern, and security features (e.g., watermarks). The amount calculating module 206 further compares the analysed data with pre-defined profiles of different currency types to identify the amount of the currency.

The request generating module 208 generates a currency deposit request, when the child submits a first approval request through an interactive display 116 for currency deposit. The request generating module 208 adds the amount of the currency in a structured deposit request to generate the currency deposit request. The request generating module 208 also generates a currency withdrawal request, when the child submits a second approval request through the interactive display 116 for currency withdrawal.

The communicating module 210 communicates at least one of the currency deposit request or the currency withdrawal request to a user device 106 through a server 104 to get approval for the currency deposit or currency withdrawal by the child from a parent/guardian. The approval receiving module 212 receives the approval for the currency deposit or currency withdrawal from the user device 106 to credit or withdraw the currency into or from the piggy bank 102.

The transaction module 214 credits the currency into the piggy bank 102, when the approval for the currency deposit is received at the approval receiving module 212. The transaction module 214 updates a balance of the piggy bank 102 based on the credited currency and stores in the first database 200. The transaction module 214 allows the child to withdraw the currency from the piggy bank 102, when the approval for the currency withdrawal is received at the approval receiving module 212. The transaction module 214 sends a control signal to the relay switch 112, which deactivates the lock mechanism for the storage space of the currency to access the currency, when the currency withdrawal request is approved by the parent/guardian. After withdrawal, the transaction module 214 updates the balance of the piggy bank 102 based on the withdrawn currency. The transaction module 214 may update the balance by incrementing a variable or update the first database 200 to reflect the balance.

The displaying module 216 displays the balance on the interactive display 116 of the piggy bank 102. The displaying module 216 further displays messages related to the status of approval and the amount deposited or withdrawn on the interactive display 116.

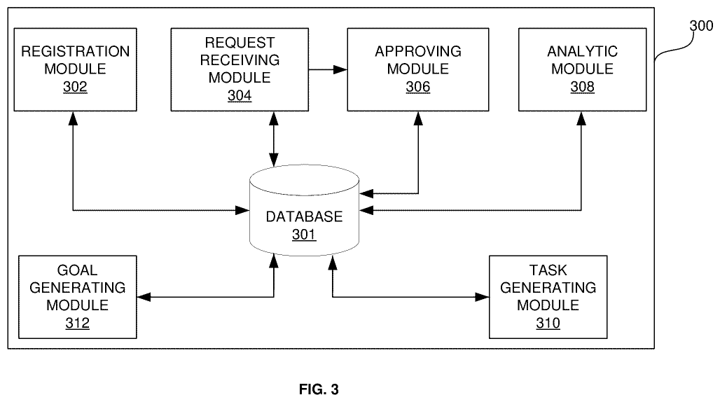

FIG. 3 is a block diagram that illustrates modules associated with a user interface 300 of user device 106 of FIG. 1 according to some embodiments herein. The user device 106 associated with the parent/guardian includes a second database 301 and accesses the user interface 300 provided by a server 104. The second database 301 stores data and configurations used by one or more modules. These modules, when executed via the user interface, facilitate monitoring a saving activity of children to foster financial management skills in children. The one or more modules include a registration module 302, a request receiving module 304, an approving module 306, an analytic module 308, a task generating module 310, and a goal generating module 312.

The registration module 302 enables a parent/guardian (users) to create an account by registering with a mobile number. The parent/guardian may provide name, nick name (optional) and generate a PIN to create the account by agreeing with the service terms and conditions. The parent/guardian logs in to the account using the mobile number and PIN. The registration module 302 further enables the parent/guardian to create a member by providing the details including name, nickname (optional), date of birth, gender and relationship type. The created members are added under the family members of the parent/guardian.

The request receiving module 304 receives a currency deposit request or a currency withdrawal request from a piggy bank 102, when a child raises a first approval request with the piggy bank 102 for currency deposit or a second approval request for currency withdrawal. The approving module 306 enables the parent/guardian to approve the currency deposit request or currency withdrawal request and sends the approval status to the piggy bank 102.

The analytic module 316 tracks the savings of the child over a period of time and helps to set financial goals for the child based on the savings. The task generating module 312 enables the parent/guardian to create at least one task with a timeline for completion and a corresponding reward. The goal generating module 314 enables the parent/guardian to create at least one goal with a timeline for achieving the goal and monthly contribution of the child to achieve the goal. The at least one task or goal may be displayed in the interactive display 116 of the piggy bank 102 as pending tasks/goals.

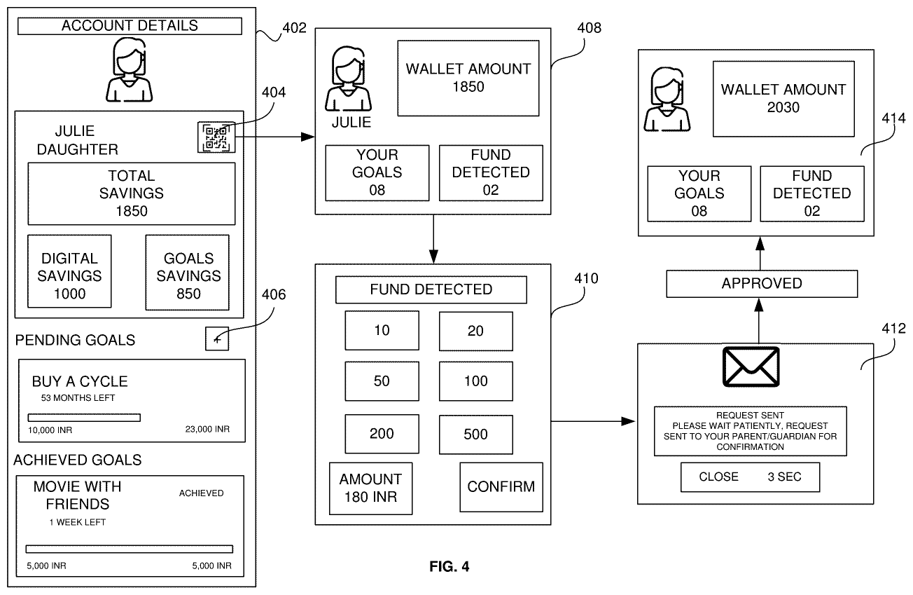

FIG. 4 illustrates exemplary user interfaces of that display monitoring of saving activity of child according to some embodiments herein. The exemplary user interfaces are displayed on an interactive display 116 of the piggy bank 102. A user interface 402 shows account details of the child (for example, Julie). The parent/guardian scans a Quick Response (QR) code 404 associated with the piggy bank 102 of the child using a user device 106. On successful linking of the user device 106 with the piggy bank 102 of the child, the parent/guardian is presented with a user interface 408 that shows the account details of the child including the current wallet amount. A user interface 410 shows currency detected in piggy bank 102, if the currency is detected by a sensor unit 110 of the piggy bank 102. An interactive display 116 shows a message 412 to the child that a request for the currency deposit has been sent to the parent/guardian and awaiting confirmation. The parent/guardian approves the request by clicking the confirm button on the user interface 410. The updated amount is shown in the account details of the child at user interface 414.

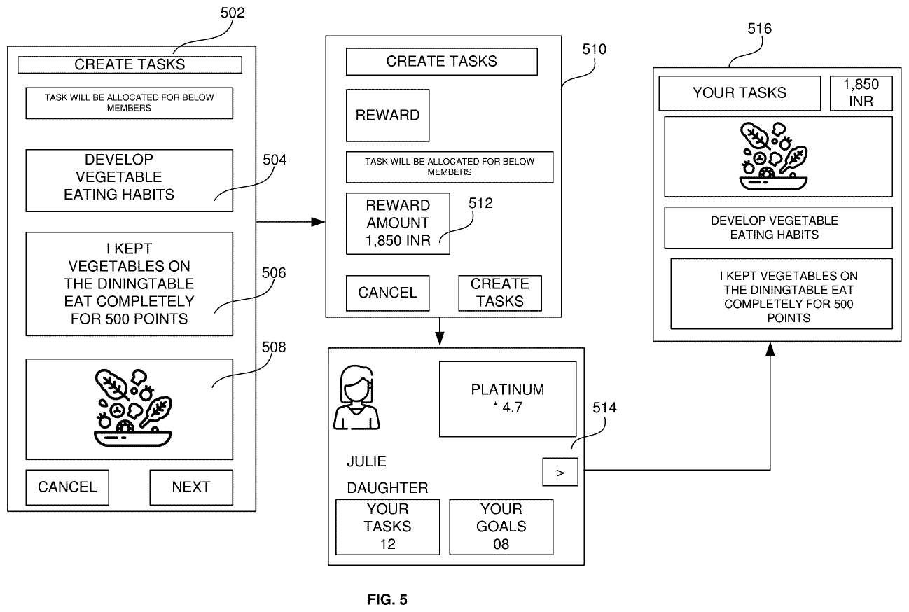

FIG. 5 illustrates exemplary user interfaces that show creating tasks for a child by a parent/guardian according to some embodiments herein. Interface 502 includes a title of a task 504, the description of the task 506, and an image relevant to the task 508. Interface 510 shows a reward amount 512 allocated for completing the task by the child. The interactive display 116 presents an interface 514 showing the total number of tasks and the description of the pending task is displayed on the interface 516.

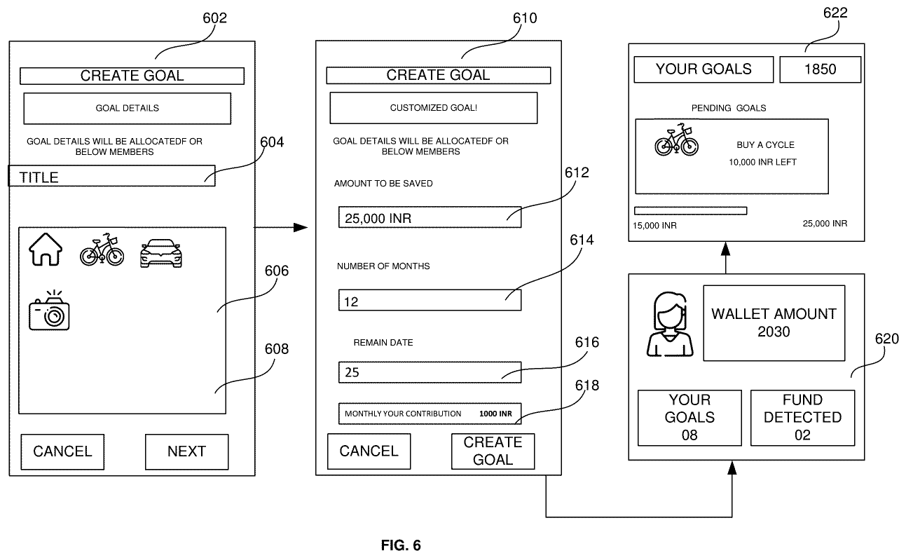

FIG. 6 illustrates exemplary user interfaces that show creating goals for a child by a parent/guardian according to some embodiments herein. The parent/guardian creates goals using a user interface 602. The goals may be created by providing a goal title 604 and a relevant image 606. A user interface 610 facilitates the parent/guardian to provide the amount to be saved 612 for the goals, the number of months allocated for completion of the goal 614, and the date to remain the deposit of currency into the piggy bank 102. The parent/guardian can provide a monthly contribution 618 for the created goal. The created goal is added to the goal list of the children as shown in interface 620 and displayed as pending goals as sown in interface 622 in an interactive display 116 of the piggy bank 102.

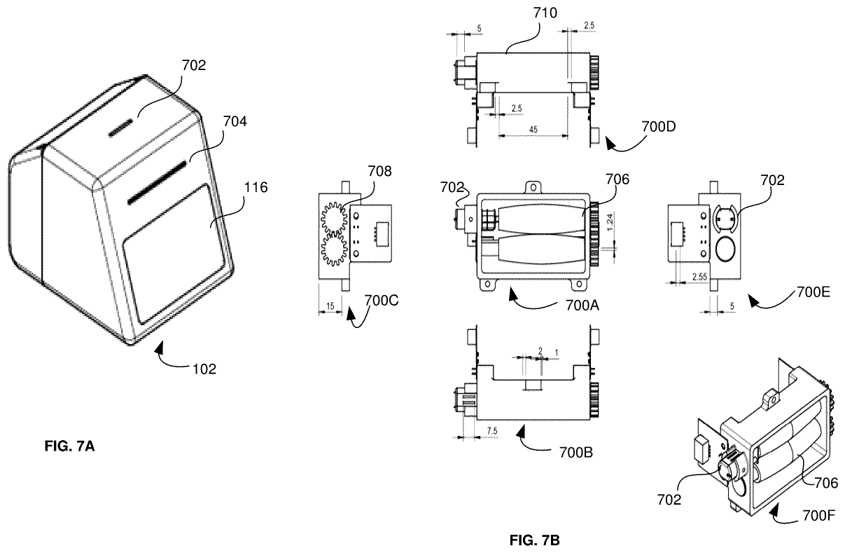

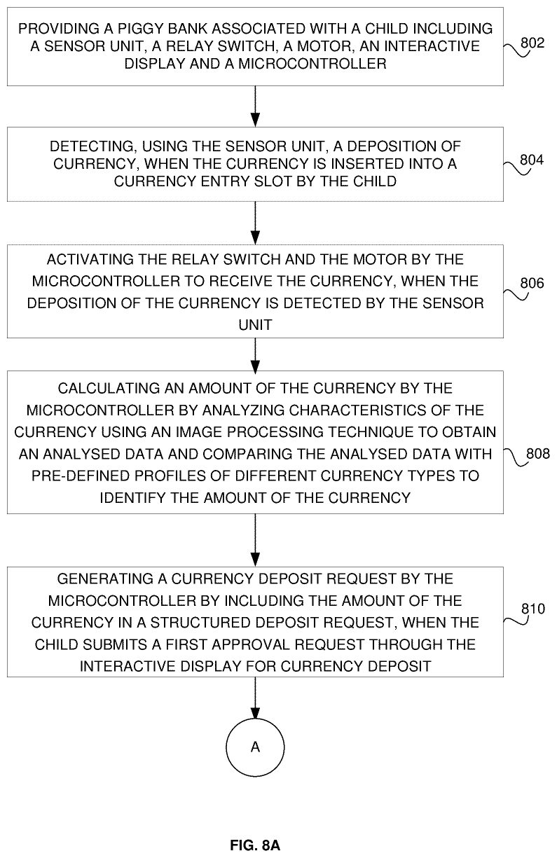

FIG. 7A is an exemplary view of a piggy bank 102 of FIG. 1 according to some embodiments herein. An outer shell of the piggy bank 102 is shown in FIG. 7A. As shown in FIG. 7A, the piggy bank 102 includes a first currency entry slot 702A through which a child inserts the coins and a second currency entry slot 700B through which the child inserts the banknotes. The piggy bank 102 further includes an interactive display 116 that enables the users (child and parent) to interact with the piggy bank 102 while performing saving activity.

FIG. 7B is an exemplary view that illustrates different views of a piggy bank 102 of FIG. 1 according to some embodiments herein. 700A shows a top view, 700B shows a bottom view, 700C shows a front view, 700D shows a left side view, 700E shows a right side view, and 700F shows isometric view of the piggy bank 102. The piggy bank includes a currency entry slot 702, one or more rollers 706, a gear mechanism 708 associated with a motor 114, and a housing 710. The housing 710 houses all the mechanisms of currency movement. The rollers 706, and the gear mechanism 708 are associated with the motor 114 and are configured to pull the currency when a child inserts the currency into the currency entry slot 702.

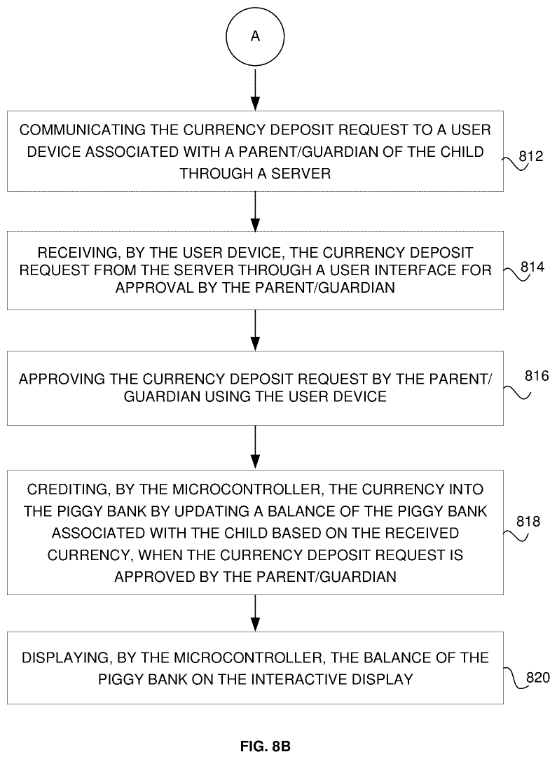

FIGS. 8A-8B are flow diagrams that illustrates a method monitoring saving activity of children to foster financial management skills using a system 100 of FIG. 1 according to some embodiments herein. At step 802, a piggy bank 102 associated with a child including a sensor unit 110, a relay switch 112, a motor 114, an interactive display 116 and a microcontroller 118 is provided. At step 804, a deposition of currency is detected using the sensor unit 110, when the currency is inserted into a currency entry slot by the child. At step 806, the relay switch 112 and the motor 114 are activated by the microcontroller 118 to receive the currency, when the deposition of the currency is detected by the sensor unit 110. At step 808, an amount of the currency is calculated by the microcontroller 118 by analyzing characteristics of the currency using an image processing technique to obtain an analysed data and comparing the analysed data with pre-defined profiles of different currency types to identify the amount of the currency. At step 810, a currency deposit request is generated by the microcontroller 118 by including the amount of the currency in a structured deposit request, when the child submits a first approval request through the interactive display 116 for currency deposit. At step 812, the currency deposit request is communicated to a user device 106 associated with a parent/guardian of the child through a server 104. At step 814, the user device 106 receives the currency deposit request from the server 104 through a user interface for approval by the parent/guardian. At step 816, the currency deposit request is approved by the parent/guardian using the user device 106. At step 818, the currency is credited into the piggy bank 102 by the microcontroller 118 by updating a balance of the piggy bank 102 associated with the child based on the received currency, when the currency deposit request is approved by the parent/guardian. At step 820, the balance of the piggy bank 102 is displayed by the microcontroller 118 on the interactive display 116.

In some embodiments, the method includes (i) generating a currency withdrawal request by the microcontroller 118 by including an amount of currency to be withdrawn in a structured withdrawal request, when the child submits a second approval request through the interactive display 116 for currency withdrawal; (ii) transmitting the currency withdrawal request to the user device 106 for the approval; (iii) allowing the child to withdraw the currency from the piggy bank 102 using the microcontroller 118 by controlling the relay switch 112 and the motor 114, when the currency withdrawal request is approved by the parent/guardian through the user interface; and (iv) updating the balance of the piggy bank 102 by the microcontroller 118 based on the withdrawn currency.

If the parent/guardian denies the currency deposit request or currency withdrawal request, the status of denial is displayed on the interactive display 116.

The system 100 allows children to engage with other users or participate in financial challenges or competitions, which can create a supportive and collaborative environment where children can learn from one another and develop a sense of community responsibility. The system 100 provides learning on financial planning where the parents can also impart basic financial planning skills to their children, such as distinguishing between needs and wants, making informed spending decisions, and understanding the concept of financial security. The system 100 allows parents to actively participate in their children's financial education, which strengthens the parent-child relationship and foster a sense of responsibility and accountability in the child. The system 100 provides a sense of accomplishment and motivation, teaching them the value of perseverance and discipline in reaching their objectives. The system 100 provides technological proficiency to children where they can become more proficient with technology, gaining valuable skills that are becoming increasingly essential in the digital era.

The system 100 provides an easy way to save money daily without having to look for currency notes and coins. The system 100 provides easy access to the child's bank account and their money makes the kids accountable. Parents will be worry-free as they have set aside money for their child's future. Parents and grandparents can transfer their money knowledge easily to the next generation. Early adoption of the system can improve children's habits that ensure their strong financial future.

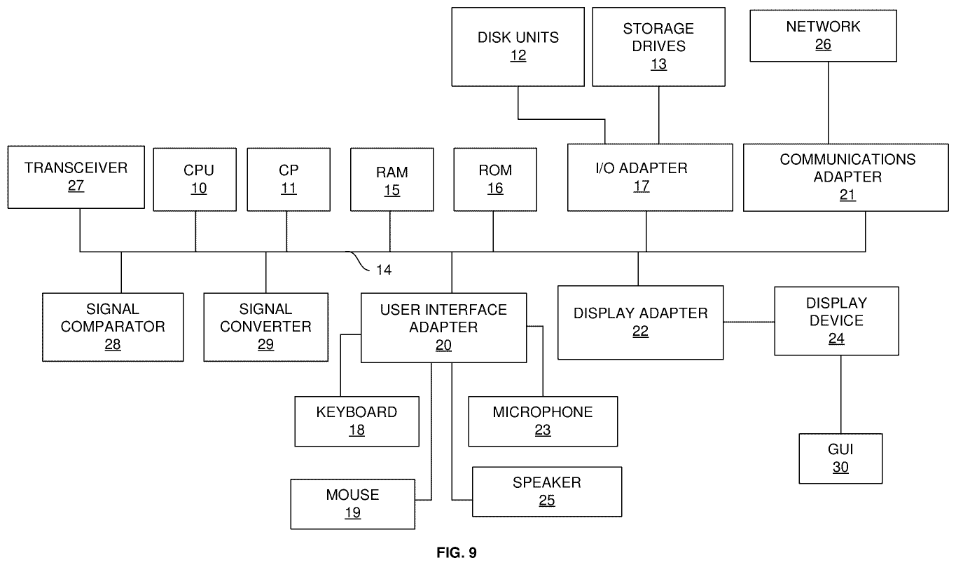

A representative hardware environment for practising the embodiments herein is depicted in FIG. 9, with reference to FIGS. 1 through 8. This schematic drawing illustrates a hardware configuration of a server 104/computer system in accordance with the embodiments herein. The server 104/computer includes at least one processing device 10 and a cryptographic processor 11. The special-purpose CPU 10 and the cryptographic processor (CP) 11 may be interconnected via system bus 14 to various devices such as a random access memory (RAM) 15, read-only memory (ROM) 16, and an input/output (I/O) adapter 17. The I/O adapter 17 can connect to peripheral devices, such as disk units 12 and tape drives 13, or other program storage devices that are readable by the system. The server 104/computer can read the inventive instructions on the program storage devices and follow these instructions to execute the methodology of the embodiments herein. The server 104/computer system further includes a user interface adapter 20 that connects a keyboard 18, mouse 19, speaker 25, microphone 23, and/or other user interface devices such as a touch screen device (not shown) to the bus 14 to gather user input. Additionally, a communication adapter 21 connects the bus 14 to a data processing network 26, and a display adapter 22 connects the bus 14 to a display device 24, which provides a graphical user interface (GUI) 30 of the output data in accordance with the embodiments herein, or which may be embodied as an output device such as a monitor, printer, or transmitter, for example. Further, a transceiver 27, a signal comparator 28, and a signal converter 29 may be connected with the bus 14 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications without departing from the generic concept, and, therefore, such adaptations and modifications should be comprehend-ed within the meaning and range of equivalents of the disclosed embodiments. It is to be understood that the phraseology or terminology employed herein is for the purpose of de-scription and not of limitation. Therefore, while the embodiments herein have been de-scribed in terms of preferred embodiments, those skilled in the art will recognize that the embodiments herein can be practiced with modification within the spirit and scope of the appended claims.

What claimed is:

1. A system for monitoring activities of children to foster financial management skills in children, wherein the system comprising:
a piggy bank that is associated with a child and is configured to:
detect, using a sensor unit, a deposition of currency, when the currency is inserted by the child into a currency entry slot, wherein the currency comprises at least one of coins or banknotes;
activate, by a microcontroller, a relay switch and a motor to receive the currency, when the deposition of the currency is detected by the sensor unit;
calculate, by the microcontroller, an amount of the currency by analyzing characteristics of the currency using an image processing technique to obtain an analysed data and comparing the analysed data with pre-defined profiles of different currency types to identify the amount of the currency;
characterized in that,
generate, by the microcontroller, a currency deposit request by including the amount of the currency in a structured deposit request, when the child submits a first approval request through an interactive display for currency deposit;
communicate, by the microcontroller, the currency deposit request to a user device associated with a parent/guardian of the child through a server, wherein the user device receives the currency deposit request from the server through a user interface and enables the parent/guardian to approve the currency deposit request; and
credit, by the microcontroller, the currency into the piggy bank by updating a balance of the piggy bank associated with the child based on the received currency, when the currency deposit request is approved by the parent/guardian, thereby monitoring the activities of the children to foster financial management skills in children.

2. The system of claim 1, wherein the piggy bank is configured to generate a currency withdrawal request by the microcontroller, when the child submits a second approval request through the interactive display for currency withdrawal.

3. The system of claim 2, wherein the microcontroller is configured to send a control signal to the relay switch which deactivates a lock mechanism for a storage space of the currency to access the currency, when the currency withdrawal request is approved by the parent/guardian.

4. The system of claim 1, wherein the microcontroller displays the status of denial on the interactive display, if the parent/guardian denies the currency deposit request or currency withdrawal request.

5. The system of claim 1, wherein the user interface associated with the user device enables the parent/guardian to create at least one task with a timeline for completion and a corresponding reward, wherein the at least one task is displayed in the interactive display of the piggy bank as pending tasks.

6. The system of claim 1, wherein the user interface associated with the user device is configured to track savings of the child over a period of time and enable the parent/guardian to create at least one goal with a timeline for achieving the goal and monthly contribution of the child to achieve the goal, wherein the at least one goal is displayed in the interactive display of the piggy bank as pending goals.

7. The system of claim 1, wherein the piggy bank comprises a chip card inserting functionality that enables secure transactions, fund additions, and balance inquiries and a fingerprint sensor that enables the parent/guardian to lock and unlock the piggy bank using a fingerprint.

8. A method for monitoring activities of children to foster financial management skills, wherein the method comprising:
providing a piggy bank that is associated with a child, wherein the piggy bank comprises a sensor unit, a relay switch, a motor, an interactive display and a microcontroller;
detecting, using a sensor unit, a deposition of currency, when the currency is inserted by the child into a currency entry slot, wherein the currency comprises at least one of coins or banknotes;
activating, by a microcontroller, a relay switch and a motor to receive the currency, when the deposition of the currency is detected by the sensor unit;
calculating, by the microcontroller, an amount of the currency by analyzing characteristics of the currency using an image processing technique to obtain an analysed data and comparing the analysed data with pre-defined profiles of different currency types to identify the amount of the currency;
characterized in that,
generating, by the microcontroller, a currency deposit request by including the amount of the currency in a structured deposit request, when the child submits a first approval request through an interactive display for currency deposit;
communicating, by the microcontroller, the currency deposit request to a user device associated with a parent/guardian of the child through a server;
receiving, by the user device, the currency deposit request from the server through a user interface for approval by the parent/guardian, wherein the user device enables the parent/guardian to approve the currency deposit request; and
crediting, by the microcontroller, the currency into the piggy bank by updating a balance of the piggy bank associated with the child based on the received currency, when the currency deposit request is approved by the parent/guardian, thereby monitoring the saving activity of the children to foster financial management skills in children.

9. The method of claim 8, wherein the method comprises
(i) generating a currency withdrawal request by the microcontroller by including an amount of currency to be withdrawn in a structured withdrawal request, when the child submits a second approval request through the interactive display for currency withdrawal;
(ii) transmitting the currency withdrawal request to the user device for the approval;
(iii) allowing the child to withdraw the currency from the piggy bank using the microcontroller by controlling the relay switch and the motor, when the currency withdrawal request is approved by the parent/guardian through the user interface; and
(iv) updating the balance of the piggy bank by the microcontroller based on the withdrawn currency.

10. The method of claim 8, wherein the relay switch activates or deactivates a lock mechanism by the microcontroller by allowing or cutting off power to the motor to access a storage space of the piggy bank.
